(19) United States
(12) Patent Application Publication
(10) Pub. No.: US 2009/0108077 A1
(43) Pub. Date: Apr. 30, 2009

(54) Medical identification system and process

(76) Inventor: Carolyn J. Booze, Bellwood, IL (US)

Correspondence Address: Carolyn J. Booze, 1139 S. 23rd Ave, Bellwood, IL, 60104, US

(21) Appl. No.: 12/288,812

(22) Filed: Oct. 23, 2008

Related U.S. Application Data
(60) Provisional application No. 61/000,407, filed on Oct. 25, 2007.

(51) Int. Cl. G06K 19/06; G06K 19/02

(52) U.S. Cl. 235/488; 235/493

(57) ABSTRACT

A system and process for reliably capturing, storing, and providing personal and medical information to medical service providers.

### CROSS REFERENCE TO RELATED APPLICATIONS

This application claims the benefit of provisional patent application Ser. No. 61/000,407, filed Oct. 25, 2007 by the present inventor.

### FIELD OF THE INVENTION

The present invention relates generally to a system and method for providing a client or patient's medical information to service providers. In particular, it provides a process for obtaining and capturing the patient's medical information, in addition to a means for displaying and providing the patient's medication and personal information to medical service providers.

### BACKGROUND OF THE INVENTION

One of the routine procedures that take place thousands of times each day at hospitals and other medical facilities is the patient intake process. This process of gathering the patient's medical and personal information is vital to the provision of proper medical care. There are many obvious reasons why this information may be necessary; however, there are times when the patient may be unable to properly provide the necessary information. For example, in the case of emergency medical treatment or serious illness, the patient may be unconscious or in a coma, or just physically unable to accurately provide the necessary information.

Neck tags and wrist bracelets are known in the prior art for patient identification, but do not contain complete medical data necessary for proper treatment. In many cases the prior art identification tag or bracelet may contain the patient's name and blood type or allergies, but are not comprehensive in providing all the necessary information to properly treat a patient.

It can be quite a repetitive and time-consuming task for a person who receives medical treatment from multiple service providers to complete the multiplicity of documents required by each service provider before receiving treatment. Even if the information is given orally to a trained interviewer, in all cases the patient may not be able to accurately and completely provide the necessary information.

The Medical Identification Card system and method effectively empowers and enables a person to provide all of their pertinent medication and personal information to the service provider at one time. Best of all, the Medical Identification Card provides an accurate listing of their current medications and associated dosage information.

It is a general object of this invention to provide a system and method for providing a patient's medication and personal information to their medical service provider to ensure accurate and detailed information at the time of service.

It is another object of the present invention to provide a new and improved method of recording and providing a patient's medical information which substantially increases the amount of medical information available for patient intake and medical treatment.

It is another object to provide a process that is easy to use and inclusive of all of the steps necessary to gathering and displaying a customer's medication and personal information.

A further object of the invention is to provide a system whose output is a tangible product that addresses the need of patients to maintain current medication information.

Other additional objects and advantages of the invention will become apparent upon reading the following detailed description and upon reference to the drawing figures.

### SUMMARY OF THE INVENTION

The inventor has created a method and system for gathering and providing the patient information necessary to a medical service provider in order to provide medical treatment.

The process includes the receipt and storage of the patient's current personal and medical information, a cross-check and verification of the names and dosages of their medication, and the production of a medical information carrying means or card.

### DRAWINGS

FIG. 1 provides a listing of the steps in the process, and illustrates step 1 of the preferred process.

FIG. 2 provides an example of the information contained on the front and back of one embodiment of the medication identification card at the start of the process, as well as an example of the information shown on the front and back of the card after the patients data has been added to the card.

### DETAILED DESCRIPTION

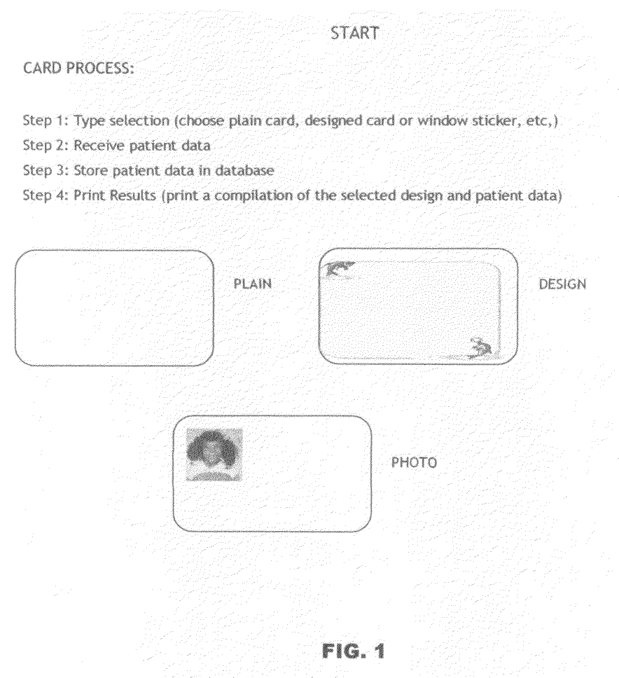

FIG. 1 describes the system process steps for outputting a patient's information onto a medical identification card. The first step is to choose the style or type of output for the medical information, whether it is a plain card, a designed card, a window sticker or other option that is selectable by the patient. The second step is to receive the patient's data that will be used to populate the medical identification card. The third step is to store the patients data in a database so that the information can be retrieved or modified as needed. The fourth step is to print or output the received information onto the selected form of the medical identification card.

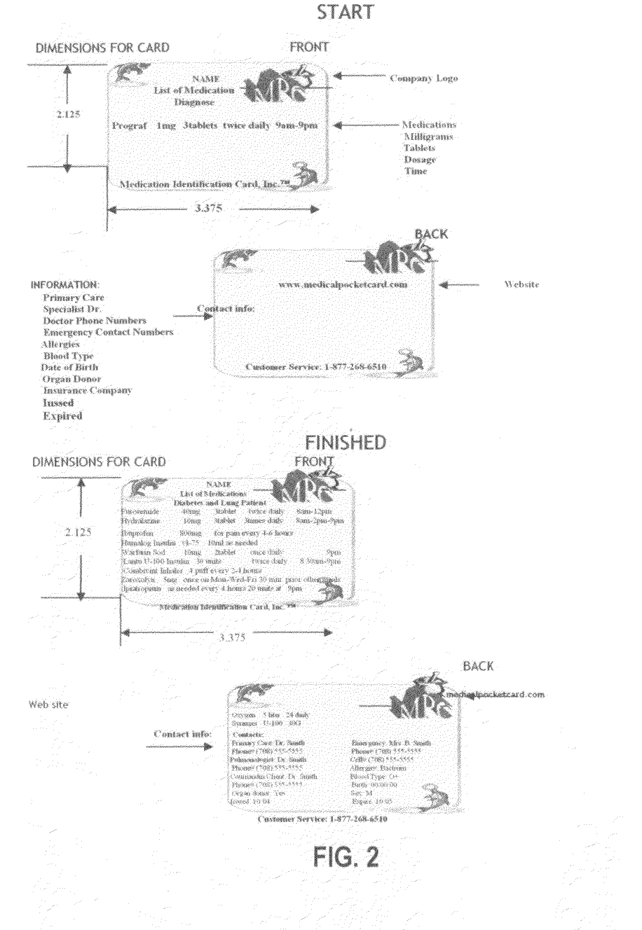

FIG. 2 provides a start and finished example of the medical identification card. The Start version shows some of the various card types, some blank, or some containing only the company information and heading with illustrations of where each section of information will be provided. The finished version displays the output medical identification card after the completion of all of the process steps has been finished.

### DESCRIPTION OF THE PREFERRED EMBODIMENT

While the system and process will be described in connection with a preferred embodiment, it will be understood that the preferred embodiment is not intended to limit the process to this embodiment. On the contrary, it is intended as an example of the system and process, which has various alternative embodiments, modifications, and equivalents that are all included within the spirit and scope of the invention.

In a preferred embodiment, the process has several steps: 1. the gathering of the patient's medication and personal information; 2. the storage of the patients medication and personal information; and 3. the output of the patients information into or onto an information carrying means to be shown to each medical service provider.

### DESCRIPTION OF ALTERNATE EMBODIMENTS

In an alternative embodiment, the information carrying means can be a medication identification card having a magnetic strip for containment of the patient's information. The information carrying means could also contain RFID technology for transmission of information. In another alternative embodiment the information carrying means could be bar coded with the patient's information for use with a bar code scanner.

Another variation of the process would include: 1. the receipt of the patients request for a medical identification card; 2. a review of the patient's information and medication by a sales representative; 3. a call to the patient to verify the accuracy of the patient's information received; 4. the entry of the patients information into a data storage and retrieval means such as a computer; and 5. printing of the patient's information onto a medication identification card.

Another variation of the process would include: 1. the receipt of the patients request for a medical identification card; 2. a review of the patient's information and medication by a sales representative; 3. a cross check of medication for adverse interactions 4. a call to the patient to verify the accuracy of the patient's information received; 5. the entry of the patients information into a data storage and retrieval means such as a computer; and 6. printing of the patient's information onto a medication identification means.

In another embodiment of the process, the customer/patient could partake in the process by accessing the internet and logging onto the card website to follow the process steps. The first step would be for the patient to select their desired type of card or output media. The second step would be to input their personal and medical information into the required fields of an input form (this information is being stored for output and retrieval purposes). The third step would be for the patient to review all of the personal and medical information they have entered, and once they have finished reviewing, they would submit the information confirming that the information received from the patient is accurate, and causes the system to save/store the input information to the database. The final step would be for the patient to press the print/output button to cause the previously selected output type to be created.

Although the descriptions above contain much specificity, they should not be construed as limiting the scope of the invention, but as merely providing illustrations of some of the presently preferred embodiments of this invention. Many other variations and modifications will be apparent to those skilled in the art, including the ability to display the received information via various means. The process can also include multiple verification steps as well as validation of the information received.

We claim:

1. A system and method of producing a medical identification card comprising:
(a) providing an input means for receiving a customers personal and medical information,
(b) storing said customers information via a storage means, and
(c) providing an output means for said customer to transport their information via an information carrying means for use when interacting with medical service providers.

2. The method of claim 1 wherein said input means is a computer based system.

3. The method of claim 1 wherein said input means and said storage means are an electronic database.

4. The method of claim 2 wherein said output means is a printing device.

5. The method of claim 1 wherein said information carrying means is a plastic card.

6. The method of claim 1 wherein said information carrying means is a card containing a magnetic strip.

7. The method of claim 1 wherein said information carrying means is a laminated card.

8. The method of claim 1 further including verifying said customers information prior to storing said customers information.

9. A system and method of producing a medical identification card comprising:
(a) receiving a patients request for a medical identification card,
(b) cross checking the patients medications for adverse reactions,
(c) entry of the patients information into a data storage and retrieval means; and
(d) outputting the patient's information to a medical identification means.

10. The method of claim 9 further including reviewing said patients information prior to cross checking the patient's medication and confirming the accuracy of the patient's information with the patient after cross checking the patient's medication.

11. The method of claim 9 wherein said data storage and retrieval means is a computer or computer based database.

12. A system and method of producing a medical identification means comprising:
(a) providing an electronic means for a patient to select their desired type of medical identification means,
(b) allowing said patient to provide their personal and medical information,
(c) allowing said patient to review the information they have entered, and make modifications as necessary before submitting the information,
(d) allowing said patient to choose whether to create their preselected type of medical identification means.

13. The method of claim 12 wherein said electronic means is an internet based device.

14. The method of claim 13 wherein said medical identification means is a substantially rigid plastic card.

15. The method of claim 12 wherein said medical identification means is a card containing a magnetic strip whereby said patient's information can be stored and retrieved.

16. The method of claim 12 wherein said medical identification means is selected from the group comprising: an RFID card, a magnetic strip card, a bar coded card, a flash memory card.

17. The method of claim 14 wherein said medical identification means further includes a photograph
